(19) United States
(12) Patent Application Publication
(10) Pub. No.: US 2002/0015422 A1
(43) Pub. Date: Feb. 7, 2002

(54) Cryptographic apparatus and cryptographic communication system

(76) Inventors: Toru Inada, Tokyo (JP); Shinobu Ushirozawa, Tokyo (JP)

Correspondence Address: BIRCH STEWART KOLASCH & BIRCH, PO BOX 747, FALLS CHURCH, VA, 22040-0747, US

(21) Appl. No.: 09/898,024

(22) Filed: Jul. 5, 2001

(30) Foreign Application Priority Data
Jul. 25, 2000 (JP) 2000-223961

(51) Int. Cl. H04J 3/24

(52) U.S. Cl. 370/474; 370/476; 713/200

(57) ABSTRACT

A cryptographic communication system in which packet data between terminals is encrypted, and which can reduce the wait time in a decryption apparatus. In the cryptographic communication system in which packet data transmitted and received between terminals is encrypted by a transmitting-side cryptographic apparatus and is decrypted by a receiving-side decryption apparatus. The cryptographic apparatus has a fragmentation determination section for making a determination as to whether there is a need for fragmentation of the packet data, a fragmentation section for dividing the packet data into a plurality of divided data groups if it is determined that there is a need for fragmentation, the fragmentation section setting the divided data groups in a plurality of divided data packets of a predetermined data structure capable of being reconstructed in a transmission destination terminal, the fragmentation section adding, to each divided data packet, control information for ensuring continuity between the divided data groups, and an encryption section for separately encrypting each of the plurality of divided data packets.

### BACKGROUND OF INVENTION

1. Field of the Invention

The present invention relates to a cryptographic apparatus and a cryptographic communication system in which packet data transmitted and received between terminals over a network is encrypted.

2. Description of the Related Art

Encapsulating encryption systems, typified by the one described in “Security Architecture for the Internet Protocol” (IPSEC-RFC2401 to 2410, The Internet Society, 1998), are known as a system for encrypting packet data transmitted and received between a plurality of terminals connected to a network. In the encapsulating encryption system, an encapsulation header and an encapsulation trailer are added to a packet of encrypted data by being respectively set before and after the packet to explicitly indicate that the encrypted data packet is an encapsulate-encrypted data field. The encrypted packet is thereby increased in length relative to the plaintext packet before encryption.

On the other hand, a maximum packet length is prescribed with respect to packets transmitted and received over a network and the length of each packet is limited so as not to exceed the maximum packet length whether encapsulating encryption is preformed or not. Even if the length of a plain text packet before encryption is not larger than the maximum packet length, the packet length may be increased to exceed the maximum packet length as a result of encapsulating encryption. In such a case, it is necessary to divide the packet into a plurality of pieces each having a length not larger than the predetermined packet length before the packet is transmitted over the network. Such packet dividing processing will be referred to as “fragmentation”.

A decryptor receiving the plurality of packets divided by the above-described fragmentation reconstructs one encapsulate-encrypted packet from the plurality of divided packets and then decrypts the encrypted packet into the plaintext packet. The reconstruction processing in the decryptor will be referred to as “reassembly processing”.

To enable packet data to be decrypted in the above-described encapsulating encryption system, it is necessary that all the plurality of packets divided by the above-described fragmentation be received by the decryptor at the time of decryption. Ordinarily, over the network connecting the transmitting-side encryptor and the receiving-side decryptor, the deliveries of packets are not uniform in delay time and no fixed order of delivery of packets is ensured. At the time of decryption of the packet data in the decryptor, therefore, a “wait time” occurs through which the completion of receiving of all the plurality of packets divided by the above-described fragmentation is awaited.

Cryptographic systems formed by considering this problem have been proposed. For example, Japanese Patent Laid-Open Publication No. 9-200195 discloses a cryptographic communication system which performs the process of previously making a determination as to whether a need for fragmentation arises, dividing packets on the basis of the result of this determination before encryption, and encapsulate-encrypting the divided packets before transmission, whereby the time through which a decryptor waits for the completion of receiving of divided packets is reduced.

A packet data processing procedure in the above-described conventional cryptographic communication system will be described with reference to FIG. 3. A transmitting terminal prepares an QUIP (Internet Protocol) packet” consisting of “IP data” 20d which is data to be transmitted to a transmission destination terminal, and an “IP header” 20b which contains control information used for designation of a route from the transmitting terminal to the transmission destination terminal, assurance of continuity of IP data between a plurality of plaintext packets, etc. The transmitting terminal adds to the IP packet a “MAC (media-specific access control) header” 20a which contains physical addresses for identification of the transmitting terminal and the transmission destination terminal, and transmits the IP packet with the MAC header 20a. Between the terminals, transmitting and receiving of packet data in accordance with the Internet Protocol (IP) are being performed, and the transmission destination terminal can receive packet data of the above-described IP packet data structure. Data packet 20 not yet encrypted after being prepared by the transmitting terminal will be referred to as “plaintext packet”.

An encryptor on the transmitting side receives the above-described plaintext packet 20 and starts encrypting the packet 20.

The object to be encrypted in this case is the IP packet portion in the plaintext packet 20, i.e., information contained in the IP header 20b and IP data 20d.

The encryptor first compares the packet length of the received plaintext packet 20 and the maximum packet length. If the packet length of the plaintext packet 20 is longer than the maximum packet length, the encryptor performs fragmentation to form divided data groups 41 and 42. The encryptor adds a “division indentifier” to each of the divided data groups 41 and 42 to indicate the continuity between the divided data groups.

The encryptor separately encrypts the divided data group 41 and 42 to obtain “encrypted data groups” 43 and 44. Further the encryptor forms encrypted packets 45 and 46 by adding to each of the encrypted data groups” 43 and 44 “ESP header” 45c and ESP trailer” 45e for explicitly indicating the encrypted data field, an IP header 45b containing control data for transmitting the encrypted data group 43 or 44 over the network, and a MAC header 45a containing the transmission destination address. The encryptor thereby transmits the encrypted packets 45 and 46 to the decryptor over the network. The above-described IP header 45b and ESP header 45c added to the encrypted data at the time of the above-described encryption will be referred to as “encapsulation header”.

As mentioned above, the delay times of the deliveries of the encrypted packets 45 and 46 over the network before reception by the decryptor vary and no fixed order of the packets delivered to the decryptor is ensured. If the decryptor first receives the encrypted packet 46 in the above-described encrypted packets 45 and 46, it detects the encapsulation header and the ESP trailer 46, thereby extracts the encrypted data 44, and decrypts this data to obtain the divided data 42.

The transmission destination terminal receives packet data in accordance with the Internet Protocol (IP), as mentioned above. However, the encrypted divided data 42 contains no IP header and has no IP packet data structure containing an IP header and IP data, so that the transmission destination terminal cannot receive the divided data 42. Therefore the decryptor temporarily stores the divided data 42 without transferring it to the transmission destination terminal.

When the decryptor receives the encrypted packet 45 containing the first half of the IP data, it extracts and decrypts the encrypted data 43 to obtain the divided data 41. When the decryptor obtains all the divided data groups 42 and 41, it reassembles the divided data groups by referring to the division identifiers respectively attached to the divided data groups to obtain the IP packet consisting of the IP header 20b and the IP data 20d. The decryptor then forms a plaintext packet 47 by adding to the IP packet a MAC address 47a containing the address for identification of the transmission destination terminal, and transmits the plaintext packet 47 to the predetermined terminal.

Ordinarily, terminals which transmit and receive packet data have the “IP reassembly function” of extracting IP data groups respectively contained in a plurality of plaintext packets successively received, and combining the plurality of IP data groups by referring to control information on the continuity of the UP data contained in the IP headers of the plaintext packets to form significant application data.

In the above-described conventional cryptographic communication system, the above-described reassembly of divided data in the decryptor and the above-described IP reassembly function of the terminals are separately performed independent of each other.

The above-described decryptor separately decrypts the received encrypted packets 45 and 46 to obtain divided data groups 41 and 42. The divided data groups 41 and 42, however, are obtained as a result of fragmentation of the IP header 20b and the IP data 20d in the original plaintext packet 20, include no IP headers containing control information necessary for identification as significant IP packets, and have no IP packet data structure, so that each of the divided data groups 41 and 42 cannot be transmitted to the transmission destination terminal. It is, therefore, necessary for the decryptor to temporarily store the decrypted divided data groups 42, 41 and to form the IP packet consisting of the IP header 20b and the IP data 20d receivable by the transmission destination terminal by reassembling the divided data groups when all the divided data groups are obtained.

However, the delay times of the deliveries of packets over the network vary and no fixed order of delivery of the plurality of packets 45 and 46 received by the decryptor is not ensured, as described above. Therefore, a “wait time” occurs between the time when the decryptor receives the first decrypted packet 45 and the time when the decryptor forms and transmits the plaintext packet 47. The wait time caused in the decryptor during packet transmission reduces the packet transmission performance of the network.

### SUMMARY OF THE INVENTION

In view of the above-described problem, an object of the present invention is to provide a cryptographic apparatus which generates an encrypted packet of a predetermined data structure such that the wait time in the decryptor can be reduced by suitably using the application data IP reassembly function with which terminals used to transmit and receive packet data ordinarily are provided and a cryptographic communication system to which the cryptographic apparatus is applied.

With the above objects in view, the cryptographic apparatus of the present invention comprises plaintext packet receiving means for receiving packet data transmitted and received between terminals, fragmentation determination means for making a determination as to whether there is a need for fragmentation of the packet data by computing the packet length when the packet data is encrypted and by comparing the computed packet length with a predetermined packet length; fragmentation means for dividing the packet data into a plurality of divided data groups if it is determined that there is a need for fragmentation of the packet data as a result of said determination, said fragmentation means setting the divided data groups in a plurality of divided data packets of a predetermined data structure capable of being reconstructed in a transmission destination terminal, said fragmentation means adding, to each divided data packet, control information for ensuring continuity between the divided data groups; encryption means for separately encrypting the plurality of divided data packets to form a plurality of encrypted packets; and encrypted packet transmitting means for transmitting the plurality of encrypted packets to the transmission destination terminal.

The cryptographic communication system in which packet data transmitted and received between terminals is encrypted by a transmitting-side cryptographic apparatus and is decrypted by a receiving-side decryption apparatus; said system may comprises a decryption apparatus which receives the plurality of encrypted packets transmitted from said cryptographic apparatus, separately decrypts each of the plurality of encrypted packets into the divided data packet, and transmits the plurality of divided data packets to a transmission destination terminal in the decryption order and a terminal which receives the plurality of divided data packets and reconstructs the divided data groups on the basis of the control information added to each divided data packet to obtain the packet data.

### BRIEF DESCRIPTION OF THE DRAWINGS

FIG. 1 is a diagram showing the configuration of a cryptographic communication system in Embodiment 1 of the present invention;

FIG. 2 is a diagram showing a packet data processing procedure in the cryptographic communication system in Embodiment 1 of the present invention; and

FIG. 3 is a diagram showing a packet data processing procedure in a conventional cryptographic communication system.

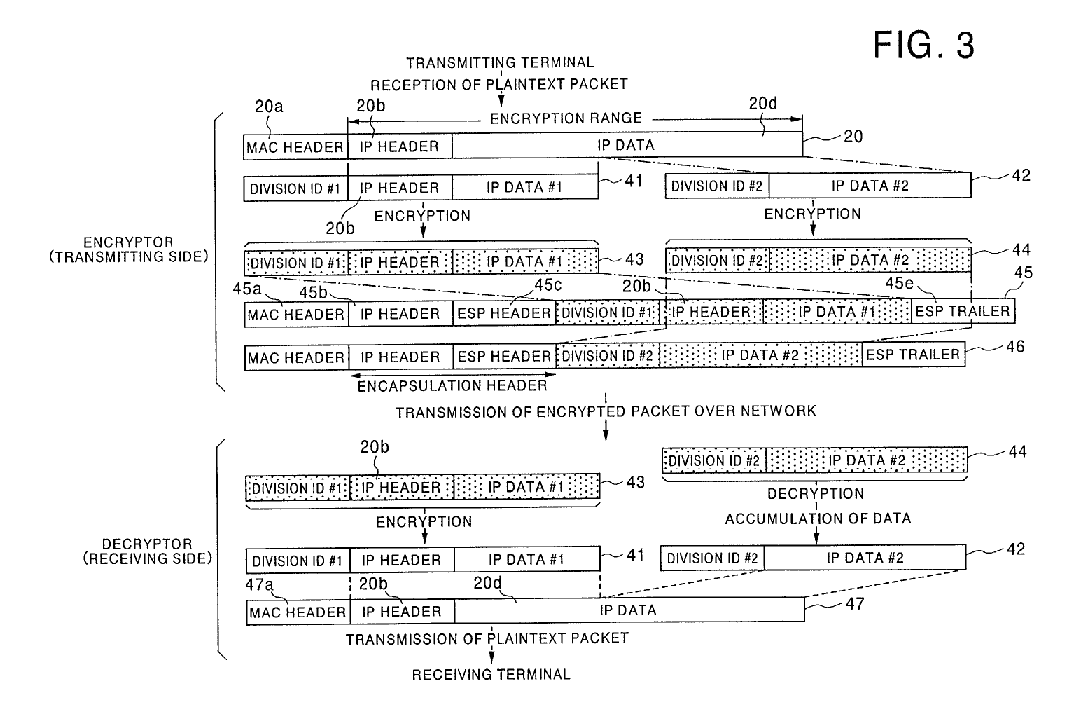

### DESCRIPTION OF THE PREFERRED EMBODIMENT

Embodiment 1.

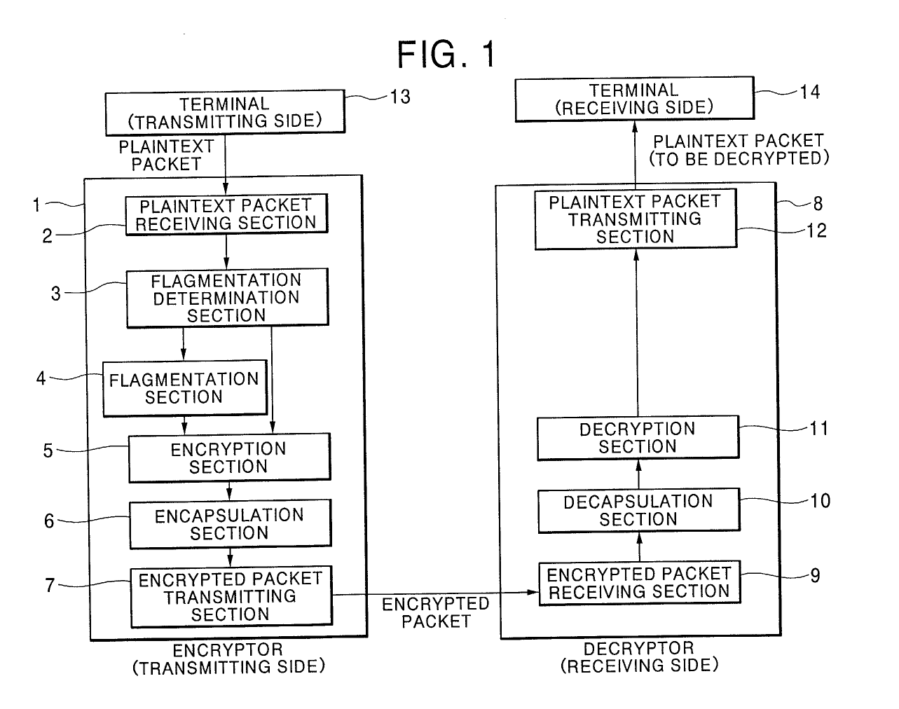

FIG. 1 is a diagram showing the configuration of a cryptographic communication system which represents Embodiment 1 of the present invention. The system shown in FIG. 1 includes a terminal 13 which transmits significant application data by setting the data in plaintext packets, an encryptor 1 which receives the plaintext packets from the transmitting terminal 13 and decrypts the received plaintext packets, a decryptor 8 which decrypts the encrypted packets received over a network to obtain the plaintext packets, and a terminal 14 which receives the decrypted plaintext packets from the decryptor 8.

The transmitting terminal 13 and the encryptor 1 are connected to a safe network, e.g., a network in an enterprise free from the risk of interception by a third party and transmit and receive non-encrypted plaintext packets over the network. The decryptor 8 and the receiving terminal 14 are also connected to a similar network and transmit and receive a non-encrypted plaintext packets over the network. This type of network will be referred to as “plaintext network”.

On the other hand, the plaintext networks are connected to each other by a wide area network, e.g., the Internet involving a risk of interception or theft of communication data by a third party. In Embodiment 1 of the present invention, therefore, packet data exchanged by communication over the wide area network is transmitted after being encrypted by the encryptor 1 and is received in the encrypted state by the decryptor 8. This network will be referred to as “cryptographic network”.

The encryptor 1 has a plaintext packet receiving section 2 which receives a plaintext packet from the transmitting terminal 13 over the plaintext network, a fragmentation determination section 3 which makes a determination as to whether there is a need for fragmentation at the time of encapsulating encryption of the plaintext packet, and a fragmentation section 4 which fragments the plaintext packet according to the result of determination made by the fragmentation determination section.

The encryptor 1 also has an encryption section 5 which encrypts the data fragmented by the fragmentation section 4, an encapsulation section 6 which forms an encrypted packet by encapsulating the encrypted data, and an encrypted packet transmitting section 7 which transmits the encrypted packet to the decryptor 8 over the cryptographic network.

On the other hand, the decryptor 8 has an encrypted packet receiving section 9 which receives the above-mentioned encrypted packet over the cryptographic network, a decapsulation section 10 which extracts the encrypted data from the encrypted packet, a decryption section 11 which decrypts the extracted encrypted data into the plaintext packet, and a plaintext packet transmitting section 12 which transmits the decrypted plaintext packet to the receiving terminal 14 over the plaintext network.

In Embodiment 1 of the present invention, the terminals 13 and 14 perform data communication by setting significant application data in packets in accordance with the Internet Protocol (IP). Ordinarily, terminals which perform packet data communication have the “IP fragmentation function” for dividing transmission-object application data into a plurality of IP data groups at the time of transmission of the application data and adding to each IP data group an IP header containing control information for ensuring continuity between the IP data groups, and the “IP reassembly function” of reassembling the application data on the basis of the control information for ensuring continuity between the IP data groups at the time of reception of the IP packets. Also in Embodiment 1 of the present invention, the terminals 13 and 14 have the IP fragmentation function and the IP reassembly function.

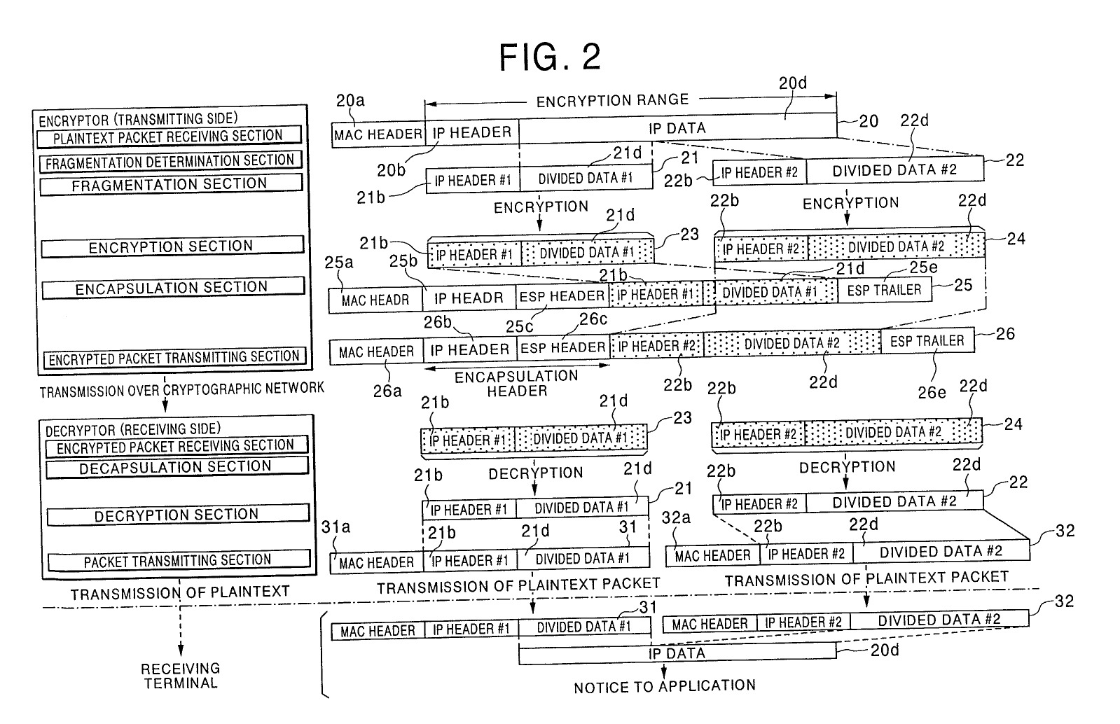

The operation of the cryptographic communication system arranged as described above will now be described with reference to FIG. 2, which is a diagram showing a packet data processing procedure in the cryptographic communication system in Embodiment 1 of the present invention.

The plaintext packet receiving section 2 of the cryptographic apparatus 1 receives a plaintext packet 20 from the transmitting terminal 13. The plaintext packet 20 contains IP data 20d, a MAC header 20a in which a physical address of the transmission destination terminal 14 is set, and an IP header 20b in which are set control information for designating a connection route from the transmitting terminal 13 to the transmission destination terminal 14 and control information for ensuring continuity between IP data groups.

The plaintext packet 20 is then transferred to the fragmentation determination section 3. The fragmentation determination section 3 makes a determination as to whether there is a need for fragmentation of the plaintext packet 20. The fragmentation determination section 3 first computes the packet length of the combination of the plaintext packet 20 with an encapsulation header and an ESP trailer added thereto, and compares the computed packet length with a prescribed maximum packet length. If the computed packet length is longer than the prescribed maximum length, the fragmentation determination section 3 determines that there is a need for fragmentation before encryption. For example, if the maximum packet length of packets to be transmitted over the cryptographic network is prescribed within 1500 bytes, and if the total data length from the encapsulation header to the ESP trailer, computed by the fragmentation determination section 3, is longer than 1500 bytes, the fragmentation determination section 3 determines that there is a need for fragmentation.

When the fragmentation determination section 3 determines that there is a need for fragmentation, it determines the number of groups into which the IP data is divided and the data length of each group. The data length of each divided group is determined so that the total data length when the encapsulation header and the ESP trailer are added to each divided data group does not exceed the prescribed maximum packet length.

The fragmentation determination section 3 then transfers the plaintext packet 20 to the fragmentation section 4 and instructs the same to fragment the IP data. Receiving this instruction, the fragmentation section 4 fragments the IP data according to the number of divided groups and the data length determined as described above. Fragmentation of the IP data performed by the fragmentation section 4 will be described below.

The fragmentation section 4 divides the IP data 20d of the plaintext packet 20 into divided data groups 21d and 22d according to the number of divided groups and the data length determined by the fragmentation determination section 3.

To enable the divided data groups 21d and 22d to be reassembled in the transmission destination terminal 14, the fragmentation section 4 forms a plurality of divided data packets of a data structure such that each data packet can be directly received by the terminal 14. In Embodiment 1 of the present invention, data communication is performed between the terminals in accordance with the Internet Protocol (IP), as mentioned above, and the transmission destination terminal 14 can receive IP packets. Therefore the fragmentation section 4 forms divided data packets 21 and 22 of the IP packet data structure and sets the divided data groups 21d and 22d in the divided data packets 21 and 22, respectively.

In the divided data packets 21 and 22, IP headers 21b and 22b are respectively attached to the divided data groups 21d and 22d. Each of the IP headers 21b and 22b contains information on transmission control of the divided data packet. The control information contained in the IP headers 21b and 22b includes control information prepared on the basis of control information contained in the IP header 20b of the plaintext packet 20, and other control information added by the fragmentation section 4 to designate the continuity of the divided data groups 21d and 22d.

For example, as control information designating the continuity of the divided data groups, a “flag indicating the existence of any other divided data group continuing to the corresponding divided data group” and a “number indicating the order of the divided data group” are contained in each of the IP header 21b and 22b in the divided data packets. Further, a “flag indicating that the divided data group is the final one” is contained in the IP header 22b of the final divided data group 22d.

As a result of the above-described fragmentation by the fragmentation section 4, each of the divided data packets 21 and 22 has an IP packet data structure such as to be directly receivable by the transmission destination terminal 14, and the control information designating the continuity of the divided data groups is contained in each of the IP headers 21b and 22b in the divided data packets. Therefore, the terminal 14 receiving the divided data packets 21 and 22 can restore the IP data 20d of the original plaintext packet from the divided data packets 21 and 22 by using the above-described IP reassembly function that the terminal 14 has.

After the completion of fragmentation performed by the fragmentation section 4, the divided data packets 21 and 22 are supplied to the encryption section 5. The encryption section 5 separately encrypts the divided data packets 21 and 22 to form encrypted data groups 23 and 24. The encapsulation section 6 adds to the encrypted data group 23 an ES header 25c and an ESP trailer 25e for explicitly indicating the encrypted data region, and an IP header 25b in which control information for transmitting the encrypted data over the cryptographic network, thereby forming an encrypted packet 25. Similarly, the encapsulation section 6 adds to the encrypted data group 24 an ESP header 26c, an ESP trailer 26e, and an IP header 26b, thereby forming an encrypted packet 26.

The encrypted packet transmitting section 7 then reads out the physical address of the transmission destination terminal 14 from the MAC header 20a of the plaintext packet 20, and adds MAC headers 25a and 26a to the encrypted packets 25 and 26 on the basis of the physical address read out. The encrypted packets 25 and 26 with the MAC headers added thereto are transmitted to the decryptor 8 over the cryptographic network. The packet data processing procedure in the encryptor 1 has been described with respect to the case where it is determined that there is a need for fragmentation of the IP data.

When the fragmentation determination section 3 determines that there is no need for fragmentation of the IP data, it directly delivers to the encryption section 5 the IP header 20b and IP data 20d of the received plaintext packet 20 as data to be encrypted. The encryption section 5 encrypts the IP header 20b and the IP data 20d, and the encapsulation section 6 encapsulates the encrypted data by adding IP headers, ESP headers and ESP trailers to from encrypted packets. The encrypted packet transmitting section 7 transmits the encrypted packets to the decryptor 8 over the cryptographic network. In this case, IP data fragmentation is not performed by the fragmentation section 4.

A processing procedure in the decryptor 8 will next be described. The encrypted packet receiving section 9 first receives the fragmented encrypted packets 25 and 26. The delay times of the deliveries of the packets 25 and 26 to the decryptor 8 vary and no fixed order of delivery of the encrypted packets is not ensured. A description will be made below with respect to a case where the encrypted packet 25 in a plurality of packets transmitted from the encryptor is received first.

Upon receiving the encrypted packet 25, the encrypted packet receiving section 9 transfers the encrypted packet 25 to the decapsulation section 10. The decapsulation section 10 detects the ESP header 25c and the ESP trailer 25e in the encrypted packet 25, extracts the encrypted data 23, and delivers the encrypted data 23 to the decryption section 11.

The decryption section 11 decrypts the encrypted data 23 to obtain the divided data packet 21 formed of the IP header 21b and the divided data group 21d. The plaintext packet transmitting section 11 then reads out the physical address of the transmission destination terminal 14 from the MAC header 25a in the encrypted packet 25, and adds a MAC header 31a to the divided data packet 21 on the basis of the physical address read out, hereby forming a plaintext packet 31. The formed plaintext packet 31 is immediately transmitted to the transmission destination terminal 14 over the plaintext network without being held in the decryptor.

When the decryptor 8 next receives the encrypted packet 26 over the cryptographic network, it extracts and decrypts the encrypted data 22 and forms a plaintext packet 32 in the same manner as described above and transmits the plaintext packet 32 to the transmission destination terminal 14.

After receiving the plaintext packets 31 and 32 from the decryptor 8 over the plaintext network, the terminal 14 reads out from the each of IP headers 21b and 22b of the plaintext packets the control information for ensuring continuity of the divided data groups 21d and 22d. Finally, the terminal 14 combines the divided data groups 21d and 22d in the plaintext packets on the basis of the control information by using the application data IP reassembly function, thereby obtaining the IP data 20d formed in the transmitting terminal 13.

In the thus-arranged cryptographic communication system in Embodiment 1 of the present invention, the encryptor 1 divides the IP data 20d in the plaintext packet 20, forms a plurality of divided packet data groups 21 and 22 of the IP packet data structure capable of being reconstructed in the transmission destination terminal 14, and separately encapsulate-encrypts and transmits these divided packet data groups. On the other hand, the decryptor 8 on the receiving side performs only decryption of each encrypted packet, and reassembly of the divided data groups 21d and 22d is performed by using the IP reassembly function of the receiving terminal 14. Thus, it is not necessary for the decryptor 8 to reassemble the divided data groups 21d and 22d, and the wait time required to receive all the fragmented encrypted packets and to reassembly the divided data groups is eliminated. Consequently, it is possible to improve the packet transmission performance of the network.

In the cryptographic communication system in Embodiment 1 of the present invention, data communication is performed between the terminals in accordance with the Internet Protocol (IP). However, the transmission control procedure used for data communication between the terminals is not limited to the IP. Needless to say, the present invention can be advantageously applied to data communication based on any other transmission control procedure if the transmission control procedure is performed with a packet system using data communication terminals each having standardized functions for dividing and reassembling packet data. In such a case, the data structure of the divided data packets 21 and 22 formed by the encryptor 1 is provided in accordance with the transmission control procedure instead of the above-described IP packet data structure.

In the encryptor 1 of Embodiment 1, the fragmentation determination section 3 compares the packet length of the plaintext packet 20 and the prescribed maximum packet length for determination as to need/no need for fragmentation. However, the packet length used as the basis for determination as to need/no need for fragmentation is not limited to the maximum packet length. In the case where a predetermined packet length other than the maximum packet length is set as a criterion of determination as to need/no need for fragmentation, the packet length of the plaintext packet 20 may be compared with such a predetermined packet length to make a determination as to need/no need for fragmentation.

According to the present invention, as described above, the encryptor divides packet data, forms a plurality of divided packet data groups of the prescribed packet data structure capable of being reconstructed in the transmission destination terminal, and separately encrypts and transmits these divided packet data groups. The decryptor performs only decryption of the encrypted packets, and the reassembly of the divided data groups is performed by the transmission destination terminal. Thus, it is not necessary for the decryptor to reassemble the divided packet data groups, and the wait time required to wait for the completion of receiving of the plurality of divided packet data groups is eliminated, thus making it possible to improve the encrypted packet transmission performance of the network.

What is claimed is:

1. A cryptographic apparatus comprising:
plaintext packet receiving means for receiving packet data transmitted and received between terminals;
fragmentation determination means for making a determination as to whether there is a need for fragmentation of the packet data by computing the packet length when the packet data is encrypted and by comparing the computed packet length with a predetermined packet length;
fragmentation means for dividing the packet data into a plurality of divided data groups if it is determined that there is a need for fragmentation of the packet data as a result of said determination, said fragmentation means setting the divided data groups in a plurality of divided data packets of a predetermined data structure capable of being reconstructed in a transmission destination terminal, said fragmentation means adding, to each divided data packet, control information for ensuring continuity between the divided data groups;
encryption means for separately encrypting the plurality of divided data packets to form a plurality of encrypted packets; and
encrypted packet transmitting means for transmitting the plurality of encrypted packets to the transmission destination terminal.

2. A cryptographic communication system in which packet data transmitted and received between terminals is encrypted by a transmitting-side cryptographic apparatus and is decrypted by a receiving-side decryption apparatus; said system comprising:
a cryptographic apparatus according to claim 1;
a decryption apparatus which receives the plurality of encrypted packets transmitted from said cryptographic apparatus, separately decrypts each of the plurality of encrypted packets into the divided data packet, and transmits the plurality of divided data packets to a transmission destination terminal in the decryption order; and
a terminal which receives the plurality of divided data packets and reconstructs the divided data groups on the basis of the control information added to each divided data packet to obtain the packet data.
